(19) United States
(12) Patent Application Publication
(10) Pub. No.: US 2025/0345993 A1
(43) Pub. Date: Nov. 13, 2025

(54) HEATING UNIT FOR COMPOSITE PRINTING OF ARTICLES

(71) Applicant: ANISOPRINT 3D PRINTING TECHNOLOGY (SUZHOU) LIMITED, SUZHOU (CN)

(72) Inventors: MIKHAIL GOLUBEV, LUXEMBOURG (LU); FEDOR ANTONOV, LUXEMBOURG (LU)

(21) Appl. No.: 19/278,804

(22) Filed: Jul. 24, 2025

Related U.S. Application Data
(63) Continuation of application No. PCT/EP2024/053463, filed on Feb. 12, 2024.

(30) Foreign Application Priority Data
Feb. 14, 2023 (LU) 503483

(51) Int. Cl. B29C 64/209; B29C 64/295; B29K 105/10; B33Y 30/00

(52) U.S. Cl. CPC B29C 64/209; B29C 64/295; B33Y 30/00; B29K 2105/101

(57) ABSTRACT

A printhead and a heating unit (100) for the printhead are disclosed. The heating unit includes at least two guiding tubes (132, 134) including a first guiding tube (132) adapted for guiding a fiber filament to an extruder (140) of the heating unit and a second guiding tube (134) adapted for guiding a polymer filament to the extruder. The heating unit further includes a heating element (151) adapted for melting the polymer filament and a horizontal guiding channel (125) adapted for guiding the melted polymer from the second guiding tube to the extruder. The heating unit further includes a printing nozzle (123) connected to the extruder and adapted for printing a composite part by outputting the composite material outside of the heating unit.

### CROSS-REFERENCE TO RELATED APPLICATION(S)

The present disclosure is a continuation application of International application No. PCT/EP2024/053463, filed on Feb. 12, 2024, which claims priority to Luxembourg Patent Application No. LU503483, filed on Feb. 14, 2023, the disclosures of which are incorporated herein by reference in their entireties.

### TECHNICAL FIELD

This disclosure pertains to the field of additive technologies, and in particular to a printhead and a heating unit used for the manufacturing of parts and structures made of composite materials reinforced with continuous fibers.

### BACKGROUND

Known in the art are 3D printing devices using composite fibers, such as print heads intended for the manufacturing of parts or structures made of composite materials.

For example, there are many 3D-printer models including printheads of special design for printing with the use of composite materials. Composite materials, or “composites”, include components with different properties and distinct boundaries between the components. A composite material can be filled with particles, short fibers, or long fibers that can be endless or continuous fibers, to reinforce the composite material. Specifically, composites with long fibers or continuous fibers provide structural materials with the advantage of having a high stiffness and strength compared to composites without such fibers.

For the composite printing of articles and to form a structural polymer composite, such fibers are introduced into a matrix, which is typically a thermoplastic material in a solid state. A matrix is a material that bonds the fibers together or is filled with short fibers. Typically, the matrix has much lower mechanical properties than the fibers. The composite fiber is fed into an extruder by a feeding device heated to a temperature exceeding the melting temperature of the matrix material of the composite fiber and laid out through the printing nozzle onto a printing table and fused to it, which enables the forming of a composite article step by step. The heating is usually provided by a heating unit attached to or included in the printhead. Herein, the extruder is also called the extruder fiber channel.

For instance, international patent application WO 2018/190750 A1 discloses a printhead including inter alia, a mechanism for feeding a plastic filament, or more specifically a polymer filament, another mechanism for feeding a fiber, a feeding tube for the polymer filament, one or more feeding tubes for the fiber, a heating unit, a plurality of input channels and a printing nozzle having an output channel for obtaining a reinforced plastic polymer after the filament and fiber went through the heating unit.

As known in the art, FIG. 1 shows a hotend unit 1, a heat block 10 said heat block having input channels, e.g. a fiber input 12 for receiving a fiber filament 13 and intended for guiding the fiber filament towards a corresponding feeding channel 40, said feeding channel 40 being inside the heating unit 10, and a polymer input 14 for receiving a polymer filament 11 and intended for guiding the polymer filament towards a fiber corresponding feeding channel 20. The polymer filament 11, which is for instance a thermoplastic polymer, melts inside hot zones of the heating unit 10. The melted thermoplastic polymer is then fed during the print process to cover the composite fiber, thereby ensuring connection between different fibers inside one layer or different layers of an article or part to print. The plastic or polymer then goes out of the printing nozzle 60 for building up the printed article or part. It is highlighted that plastic filaments are usually much thicker than composite fibers.

A disadvantage of the known devices is that the fiber feeding channel(s) guiding the fiber(s) to the printing nozzle must comply with strict dimensional requirements and be sufficiently long and thin to finely guide the filaments, and in particular the fiber filament, from the input(s) on the top side of the printhead to the output printing nozzle on the bottom side of the heating unit.

In general, a printhead includes a part called “hotend” which is a component of the printhead responsible for melting and extruding a filament, such as the polymer filament, in a 3D printer. A hotend generally includes a heat block, a nozzle, and a thermistor, which are all working in cooperation for melting the filament and for controlling the temperature of the melted filament in view of depositing the latter in a desired location under the printhead in a very accurate way so as to create a three-dimensional object. A drawback of the known heating units and/or known hotends, is that the fiber and polymer filaments guided through the heating unit can become viscous, stick and/or cling to the inside walls of the assembly. This in turn can lead to burn the filaments and/or the inside walls, further building up a coating layer, such as a residual carbonized coating, that can eventually close the feeding channels in the heating unit. This can then provoke clogging of the whole printhead, leading the printing process to fail.

Accordingly, despite all the advances that have been made in the field of composite printing, there remains a need for printheads to avoid unwanted clogging by fibers being guided through.

Solutions to this problem usually provide an enlargement of the printhead dimensions, or of other components attached to or part of the heating unit of the printhead. Such solutions are however unsatisfactory for many applications as they make the heating unit too large and bulky, for instance providing a printing device taking up too much space or incompatible with the latter. In addition, the distance between the hot zone(s) inside the heating unit and the printing nozzle from which the printed material is outputted might also be too large in this case to ensure appropriate melting of the polymer, reducing the quality of the printing process.

Rather than further reducing the dimensions of the printhead elements, it would be advantageous to provide other solutions to avoid the fiber or polymer filaments to cling or clog the heating unit, by reducing the possible friction area for the materials in the printhead. Solutions have been sought to avoid the plastic, polymer, and other materials to burn down and stick to the walls inside the printhead and heating unit, without success for several applications.

There is therefore a need for printheads that remain small while simultaneously making the printing processes more stable and more cost-efficient, in particular for producing thermoplastic composite articles with minimum waste.

### SUMMARY

An object of the present disclosure is to solve these disadvantages, drawbacks, and problems by providing, in a first aspect, a heating unit for a printhead, the heating unit including:—at least two guiding tubes, each of the guiding tubes being adapted to be connected to an extruder, a first guiding tube among the at least two guiding tubes being adapted for guiding a fiber filament from a first inlet of the first guiding tube to the extruder, a second guiding tube among the at least two guiding tubes being adapted for guiding a polymer filament from a second inlet of the second guiding tube to the extruder,—a heating element adapted for melting the polymer filament guided in the second guiding tube to the extruder,—a horizontal guiding channel connected to the extruder and located below the first guiding tube and the second guiding tube, the horizontal guiding channel being adapted for guiding the melted polymer from the second guiding tube to the extruder,—the extruder, being adapted for forming a composite material by covering, with the melted polymer, the fiber filament guided in the first guiding tube to the extruder, and—a printing nozzle connected to the extruder and adapted for printing a composite part by outputting the composite material outside of the heating unit.

In an embodiment, each of the guiding tubes is connected to the extruder.

This enables to drastically reduce the amount of leaking, of clogging and/or of burning of a material used in a printhead intended for the printing of parts and elements, in particular composite printing. Specifically, it is possible to avoid such leaking, clogging and/or burning of this material, especially if this material is a plastic material such as a thermoplastic polymer, which can melt in a problematic manner when heated in previously known printheads. This further aims at preventing leaking, clogging, and burning altogether in the heating unit of the printhead.

In a preferred embodiment, the fiber filament is selected among a carbon fiber filament, a glass fiber filament, a composite fiber filament, an optical fiber filament, or a Kevlar fiber filament.

This enables manufacturing parts or elements with different properties depending on the type of fiber filament, in view of obtaining reinforced plastics and composites during a printing process to create parts with high strength-to-weight ratio, temperature and chemical resistance.

Specifically, a carbon fiber filament is a strong and stiff filament that enables enhancing the structural strength of printed parts, which are lightweight and high in strength. Glass fiber filaments have properties like those of carbon fiber elements but are such that the resulting parts tend to be less brittle than those made with carbon fiber filaments. A Kevlar fiber filament enables manufacturing parts with a high strength and heat resistance, further able to resist cutting and abrasion. Carbon fiber reinforced plastics can also be used as they combine the strength of carbon fiber with the flexibility of a plastic matrix, such as nylon or polyester, for creating lightweight and strong parts.

In a preferred embodiment, the polymer filament is a thermoplastic polymer filament selected from a group consisting of polyetheretherketone, polyetherketoneketone, polyetherimide, polysulfone, polyphenylsulfone and polyethersulfone.

This provides a heating unit for a highly efficient and cost effective printhead to produce materials with advantages far superior to those known. Advantageously, polyetherketoneketone (PEKK) allows for the ability to print parts at high temperatures and in high-temperature environments without significant loss of mechanical properties. Additionally, PEKK has a high strength-to-weight ratio and excellent chemical resistance, which makes it well-suited for applications in harsh environments or in the aerospace and automotive industries. Polyetherimide (PEI) provides similar advantages and is specifically suited for electronic components. Polysulfone (PSU) provides similar advantages to PEKK and PEI, and further has a high transparency and dimensional stability which makes it a good candidate for optical applications. Polyphenylsulfone (PPSU) PPSU has good dimensional stability, excellent fatigue resistance and good hydrolysis resistance, which make it highly reliable for high-performance parts in harsh environments. Advantageously, polyethersulfoneacrylonitrile (PES or PESAN) has a high rigidity, excellent dimensional stability, and good flame-retardant properties, which make it an excellent choice for structural parts and electrical components.

In other embodiments, the polymer filament is selected among acrylonitrile butadiene styrene or thermoplastic polyurethane, a biodegradable thermoplastic polymer such as polylactic acid, a copolyester such as polyethylene terephthalate glycol, and nylon.

Advantageously, acrylonitrile butadiene styrene, or ABS, has a high melting point and good strength, making it suitable for a wide range of applications. Polylactic acid, or PLA, is biodegradable and easy to use. Polyethylene terephthalate glycol, or PETG, has a high strength and durability, and is further resistant to impact, extreme temperatures and ultraviolets, making it a versatile plastic for a variety of applications. Nylon has the advantage of being strong, flexible, durable, and can be used for printing processes at low temperatures.

In a preferred embodiment, the heating unit further includes a radiator positioned around a portion of the length of and axially aligned with the vertical axis of the second guiding tube adapted for guiding the polymer filament.

In a preferred embodiment, the heating unit further includes a heat block and each of the at least two guiding tubes is fixed on an upper side of the heat block, the printing nozzle is positioned in the heat block so that the composite material is outputted outwardly from a lower side of the heat block, the lower side being opposite to the upper side, the heat block further including the heating element.

In a preferred embodiment, the heating unit further includes a pillar, the pillar being attached to the heat block, the first guiding tube being located between the pillar and the second guiding tube.

In an embodiment, the pillar is attached vertically to the heat block.

In an embodiment, if the pillar is attached vertically to the heat block, the first guiding tube, the pillar and the second guiding tube are aligned vertically with each other.

In another embodiments, the pillar can be positioned along an axis forming an angle with the first guiding tube and the second guiding tube, so that the pillar is attached horizontally or diagonally to the heat block.

In a preferred embodiment, the heat block includes a first zone, called a thermistor zone, which is adapted to host at least one thermal sensor and/or thermistor, the heat block further including a second zone, called a heater zone, which is adapted to host the heating element.

In a preferred embodiment, the heater zone includes at least one lodge adapted to host the heating element.

In a preferred embodiment, the horizontal guiding channel includes a hollow space formed in the heat block of the heating unit, the hollow space being located under the at least two guiding tubes and adapted to host a spacer of corresponding size and shape, the at least two guiding tubes being attached to the heat block.

In a preferred embodiment, the heat block includes an input bushing located under the first guiding tube adapted for guiding the fiber filament, the input bushing having an opening with a diameter adjustable for controlling the flowing of the fiber filament.

In a preferred embodiment, the heating unit further includes an empty space defining an air gap between the first guiding tube and the input bushing.

In a preferred embodiment, the heating unit further includes the spacer adapted to fit inside the horizontal guiding channel, the spacer including a solid part and a hollow part located inside the solid part, the solid part being made of a material having a high thermal conductivity, the hollow part including a narrowing cutout, the width of the cutout being large enough for guiding the melted polymer towards the printing nozzle.

In another aspect, it is proposed a printhead including:—a main bracket,—two heating units attached to the main bracket, one of the two heating units being the heating unit according to the first aspect,—a cutting mechanism attached to the main support bracket for cutting the fiber filament, and—a switching mechanism attached to the main bracket for controlling the height of at least one of the two heating units.

In a preferred embodiment, the cutting mechanism includes one or more rotatable cylindrical cutters, each rotatable cylindrical cutter including a radial hole and at least one cylindrical sleeve that is fixed to the radial hole.

In a preferred embodiment, the switching mechanism includes a lever configured for controlling the vertical position of the printing nozzle of at least one of the two heating units.

### BRIEF DESCRIPTION OF THE DRAWINGS

Other features, details and advantages will be shown in the following detailed description and on the figures, on which:

FIG. 1 is a cross-section view of a heating unit known in the art;

FIG. 2 is a cross-section view of a heating unit according to an embodiment;

FIG. 3A, FIG. 3B and FIG. 3C are schematic views of a heating unit according to an embodiment;

FIG. 4 is a schematic view of a spacer for a heating unit according to an embodiment; and

FIG. 5 is a view of a printhead including one or more heating units according to an embodiment.

Unless otherwise indicated, features common to or similar to several figures bear the same reference signs and refer to identical or elements, so that these common features are generally not described again for the sake of simplicity.

### DETAILED DESCRIPTION

The invention will be further explained with reference to the following figures and embodiments.

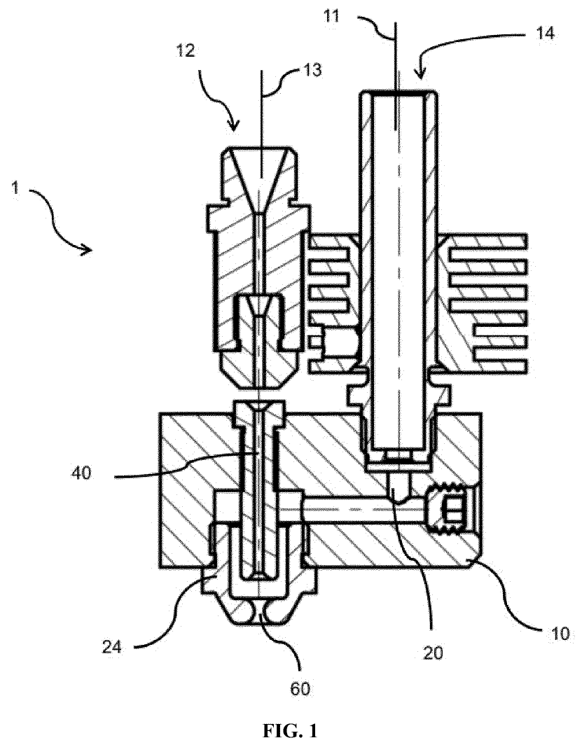

FIG. 1 was previously described as an example of a heating unit for a printhead as known in the prior art.

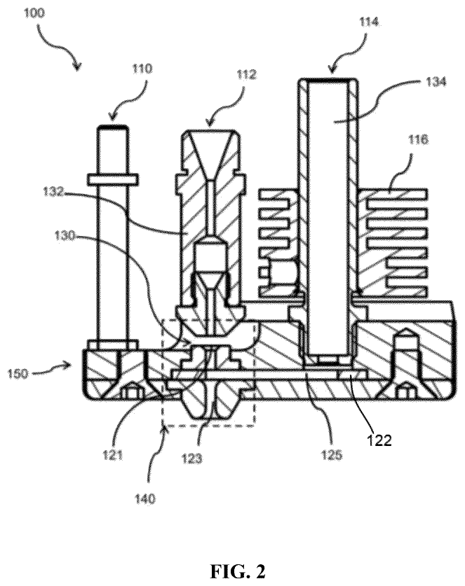

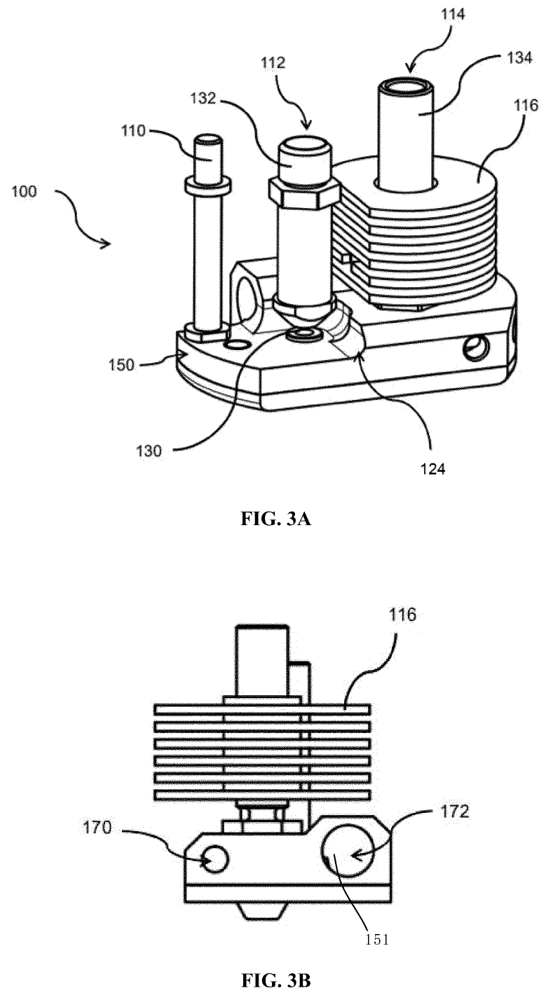

Now referring to FIGS. 2, 3A, 3B and 3C, a heating unit 100 for a printhead is shown according to an embodiment.

Specifically, in an embodiment, the heating unit 100 includes a fiber guiding tube (also referred to as a “first guiding tube”) 132 and a polymer guiding tube (also referred to as a “second guiding tube”) 134. The fiber guiding tube 132 is provided with a fiber tube input (also referred to as a “first inlet) 112, and the polymer guiding tube 134 is provided with a polymer tube input (also referred to as a “second inlet”) 114.

The heating unit further includes a heat block 150. The elements described before and in the following are attached to or are included in the heat block 150.

The fiber tube input 112 can be connected to a fiber feeding mechanism located outside of the heat block 150 while the polymer tube input 114 can be connected to a polymer feeding mechanism also located outside of the heat block 150. The fiber tube input 112 serves as an inlet for a fiber filament, i.e., for guiding the fiber filament downwards into the fiber guiding tube 132 while the polymer tube input 114 serves as an inlet for a polymer filament, i.e., for guiding the polymer filament into the polymer guiding tube 134.

In an embodiment, heating elements 151 are provided inside the heating unit 100 for heating the interior of the heating unit 100 and some or all elements of the heating unit 100. Examples of the heating elements 151 include resistance heating elements, infrared heating elements, cartridge heating elements, positive temperature coefficient elements, micathermic heating elements and ceramic heating elements.

In an embodiment, as shown in FIG. 3B, the bottom part of the heating unit 100 or of the heat block 150 of the heating unit 100 includes a first zone 170 called a thermistor zone, which is adapted to host at least one thermal sensor and/or thermistor.

In an embodiment, the bottom part of the heating unit 100 or of the heat block 150 includes a second zone 172 called a heater zone, which forms a lodge adapted to host the heating elements 151. Advantageously, the elements 121, 124 and 123 described hereafter are positioned so that they reach the same temperature when heated by the heating elements 151.

In an embodiment, the at least one thermal sensor and/or thermistor are provided inside the heating unit 100 for measuring the temperature of the inside parts of the heating unit 100.

Advantageously, the thermistor can be configured to measure the temperature of the polymer guiding tube 134 and at different points of the polymer guiding tube 134.

In an embodiment, a radiator 116 is provided around the polymer guiding tube 134, along a portion of its length and axially aligned with the vertical axis of the polymer guiding tube. The radiator 116 can include one or more further elements selected among a heater, a dissipative block, a thermistor, and a thermocouple. The radiator can further be attached to the heat block 150.

Advantageously, the radiator 116 enables dissipating excessive heat from the heating unit 100 and to reduce as much as possible the temperature of cold zones situated above the heating unit.

In an embodiment, the radiator 116 can include various dissipative elements such as a heat sinks or any type of passive component that can dissipate heat by conduction. Advantageously, the dissipative element can also be configured to minimize the temperature of any cold zones located above the heating unit.

Advantageously, such dissipative elements or passive components are made of metal, such as aluminum, and have a large surface area to help dissipate heat quickly. A dissipative element can include a thermoelectric cooler for actively cooling elements inside the heating unit or inside the heat block. A dissipative element can also be a thermal paste or a thermal grease, thereby providing a material for filling gaps or spaces in the printhead, in the heating unit or in the heat block. This also further improves the thermal conductivity between the printhead and the cooling element which help to dissipate heat more efficiently.

Advantageously, the polymer filament and the fiber filament are pushed inside the hotend using their own stiffness. After these filaments are heated inside the heating unit 100, they become flexible and loose stiffness thereby avoiding the need for pushing the filaments on a long distance when melted. In other words, the printhead including the heating unit as described herein includes an effective heat breaker, wherein a maximum temperature gradient is possible.

This enables providing a uniform temperature increase along the radiator.

In an embodiment, the printhead includes a single heating unit 100.

For instance, the heating unit 100 can be a cylindrical heater adapted to be inserted in a corresponding hole between a pillar 110 and the fiber guiding tube 132.

In other embodiments, in the heating unit 100, or the printhead including the heating unit, at least one of the heating elements 151 is configured to be heated to a temperature exceeding the melting temperature of the fiber filament or of the polymer filament which is to be fed into the fiber tube input 112 or of the polymer tube input 114.

Specifically, the heating element 151 can be heated to a temperature exceeding the melting temperature of a polymer or thermoplastic filament.

If a reinforcing fiber impregnated with a thermosetting binder and cured is used as the polymer filament, the heating element 151 can be heated to a temperature exceeding a glass transition temperature of the polymer filament.

Optionally, the temperature can be kept constant by means of a feedback control system with the use of a temperature sensor.

In an embodiment, the radiator 116, the heating element 151, the at least one thermal sensor and/or the thermistor are made of aluminum, copper, aluminum alloy, copper alloy, or any other element having a high thermal conductivity, preferably above 100 W/m K, even more preferably above 200 W/m K.

In an embodiment, the heating element 151 is adapted to melt the polymer filament inside a corresponding hot zone of the heating unit 100. The melted polymer is then pushed mechanically via a guiding channel 125 onto or into the fiber filament coming from the fiber guiding tube 132. The melted polymer is preferably under the form of a fluid plastic.

In a preferred embodiment, the guiding channel 125 is horizontal. Preferably the guiding channel 125 spreads below the two guiding tubes 132 and 134 in such a way that the outlet of each guiding tube outputs the filament into the guiding channel 125, which is preferably horizontal and located below the fiber guiding tube 132 and the polymer guiding tube 134.

In an embodiment, the guiding channel 125 is a cutout in the heat block 150. The cutout in the guiding channel 125 can also be filled with a spacer or any element filling partially the guiding channel 125.

In an embodiment, the fiber covered by the melted polymer or plastic is then extracted out of a printing nozzle 123 of the heating unit 100, so that the nozzle can build up a printed part for a composite material.

In an embodiment, the heating unit 100 has two input channels, which allow for printing using fibers that are not fused with each other and can be combined, for instance by covering one with the other. Covering the fiber with the thermoplastic inside the hotend ensures a solid structure and adhesive properties between the fibers. Examples of fibers include, for example, composite fibers impregnated with a thermosetting binder. Preferred types of used fibers have a low porosity and, accordingly, high physical and mechanical characteristics. Such fibers have the advantage of having a lower cost, as compared with fibers impregnated with a thermoplastic polymer, because the manufacturing process is much simpler.

Advantageously, this enables a manufacturing of fibers which is much easier and cheaper than for thermoplastics, i.e., pre-impregnation processes for thermoset polymers. Printing processes for thermoset and thermoplastic impregnated fibers are generally the same in terms of simplicity, but more expensive.

The diameter of the fiber tube input 112 and of the polymer tube input 114 are adapted to be compatible with the dimensions of corresponding fiber and polymer filaments. In an embodiment, the diameter of the fiber tube 112 is between 3 and 10 millimeters, for instance 5 millimeters. In an embodiment, the diameter of the polymer tube input 114 is between 1.5 and 3 millimeters, for instance 1.75 millimeters, corresponding to the diameter of polymer filaments. Diameters of composite filaments that can be used for the present embodiments can range from 0.25 millimeter to 0.8 millimeter.

Advantageously, the diameters of the through hole of each of the tube inputs 112 and 114 can be adjusted individually to optimize the printing process.

In an embodiment, the heating element 151 has a cylindrical shape with a diameter comprised 5 and 10 millimeters, (preferably 6 millimeters) and a length between 20 and 25 millimeters.

In an embodiment, the guiding tube 132 for the fiber filament includes an assembly of a main tube and a tip element. The tube and the tip element are both aligned along a common axial channel with a diameter close to that of the fiber filament.

Herein, a channel having a diameter “close to” that of a filament or fiber is defined as a channel having a diameter not larger than three times the diameter of the filament or fiber. For instance, the thickness of the fiber can be of the order or 0.35 millimeter while the diameter of the channel is of the order of 0.9 millimeter.

In an embodiment, the fitting of the fiber filament into the fiber guiding tube 132 is ensured with a conical shape of the tip element and/or of any input part of the guiding tube. This enables preserving it straightness and further preventing any buckling. This also avoids the fiber filament to miss the corresponding inlet of the heating unit whenever fed or reloaded after an optional cut of the fiber filament.

In an embodiment, under the guiding tube 132 and 134, the bottom part of the heating unit 100 includes the heat block 150 supporting a plurality of elements.

In an embodiment, the heat block 150 includes an input bushing 121 located under the fiber guiding tube 132 and aligned with the fiber guiding tube 132. The input bushing can be included in the inlet of the extruder 140 and/or serve as the inlet of the extruder 140.

In an embodiment, the extruder 140 includes at least one of the elements 121, 124 and 123. Preferably, the extruder 140 includes the input bushing 121, the washer 124 and the printing nozzle 123.

In an embodiment, the heat block includes a cap element, such as a separate cap part, adapted to fix the element(s) 121, 124 and/or 123 together inside the heat block 150. This enables having an extruder assembly 140 whose elements are connected in a single piece.

In an embodiment, the input bushing 121 has an adjustable opening, with the possibility to adjust its diameter so that the size of its inlet can be selected and/or optimized for various parameters of the fiber filament and/or printing profiles.

In an embodiment, between the fiber guiding tube 132 and the input bushing 121, the heating unit includes an empty interval 130, or empty space, defining an air gap, or “cold zone” of the heating unit 100.

Advantageously, the size of the opening, or the diameter of this opening, can be adjusted so as to form a small hole, thereby ensuring that the fiber filament, such as the plastic therein, does not leak or does not flow back upside or downside.

In an embodiment, the dimensions of the input bushing 121 are defined based on the diameter of the fiber. In the embodiment, the value of the diameter of the small hole of the input bushing 121 is larger than the value of the diameter of the fiber and smaller than three times the value of the diameter of the fiber.

For instance, the fiber can have a diameter of 0.35 millimeter while the diameter of the hole of the input bushing 121 is between 0.6 and 0.8 millimeter.

In an embodiment, the dimension of the input bushing 121 is typically between 0.6 and 1.2 millimeters, and preferably ranges from 0.8 millimeter to 1.0 millimeter.

In view of printing a part, the fiber filament going through the fiber guiding tube 132 is displaced through this cold zone to reach the extruder 140, also called extruder fiber channel. The input bushing 121 is located at the level of the inlet of the extruder 140. The input bushing 121 can include or be attached to a washer 124, e.g. a washer made of copper. The fiber filament covered by the melted polymer is then guided to the printing nozzle 123 for outputting the material to be printed and located in the bottom part of the heat block 150, the extruder 140 thereby defining a “hot zone” of the heating unit 100. In an embodiment, the extruder includes a cap adapted to cover its surrounding areas. The printing nozzle can also be hosted in the cap and the cap is preferably bolted to the main structure of the extruder.

In an embodiment, regardless of whether the printing nozzle 123 is inside the cap or whether a cap is not present, the printing nozzle 123 has a smooth surface so that the fiber is not damaged while going out of the printing nozzle.

In an embodiment, the height of the hot zone, namely the zone between the air gap and the nozzle output is larger than 20 millimeters. In another, preferred, embodiment, the height of the hot zone, namely the zone between the air gap and the nozzle output is smaller than 100 millimeters.

The diameter of the input channel of the fiber tube input 112 of the heating unit 100 is smaller than the diameter of the output channel to minimize the melt yield, when printing, through the channels for feeding the fiber filament.

The presence of the interval 130 enables defining an air gap allowing for a maximum temperature difference or, in other words, an optimal temperature gradient between the cold zone and the hot zone. When heated above a corresponding temperature, fiber filaments lose their stiffness and become hard to displace inside the heating unit without clinging, i.e., in view of merging the fiber with the polymer of the polymer filament.

Moreover, a fiber filament heated through the hot zone cannot be pushed on distances longer than several millimeters, which can impede the extrusion and printing process. Therefore, the defined air gap enables the fiber filament to remain cold and stiff when guided through and until it reaches the hot zone of the heating unit.

In an embodiment, when reaching the extruder 140, the latter serves as a printing nozzle for outputting the material to be printed outside of the heating unit 100.

This defines another advantage of the present disclosure, since in case of incorrect or excessive extrusion of the polymer filament inside the heating unit, any melted plastic might leak out of the sides of the heating unit. Worse, if the melted plastic reaches the cold zone, it might solidify and block the channels through which the fiber is guided. Advantageously, the present configuration, in combination with the air gap defined by the interval 130 between the cold zone and the hot zone of the heating unit, ensures that melted plastic cannot reach the cold zone and does not impede the printing process or lead to faulty prints.

In an embodiment and in addition to the fiber guiding tube 132 and to the polymer guiding tube 134, the pillar 110 is attached to the heat block 150 of the heating unit 100 so as to form three individual parts so assembled. This assembly is such that the fiber guiding tube 132 is arranged or located between the pillar 110 and the polymer guiding tube 134.

In an embodiment, by providing the fiber guiding tube 132 and the polymer guiding tube 134, the heating unit 100 has two inputs 112 and 114, one of these two inputs not being connected or adapted to be connected to an upper structure, such as another part of a printhead adapted to be assembled with (or connected to) the heating unit 100.

In other words, at least one of these two inputs is separated or adapted to be separated from the upper structure by another air gap. When the heating unit 100 is assembled or connected with another part of a printhead, these inputs are adapted to be precisely oriented with filament feeding channels of the upper structure.

Advantageously, the pillar 110 enables optimizing the alignment of the heating unit 100 with at least one other part of a printhead, and most especially the alignment of the fiber and polymer guiding tubes when assembling the printhead. Moreover, it is simple, fast and efficient to assemble the heating unit 110 with other parts of a printhead by positioning them so that two of their main axes are aligned. The main axes is preferably vertical.

In a particular embodiment, aligning the pillar and the polymer feeding tube with vertical axes of the other part of the printhead is sufficient to ensure optimal positioning, and thereby dimensioning, of air gaps located in between.

In an embodiment, the pillar includes a material made of a titanium allow or of stainless steel.

Advantageously, a pillar including titanium has a low thermal conductivity and high mechanical properties.

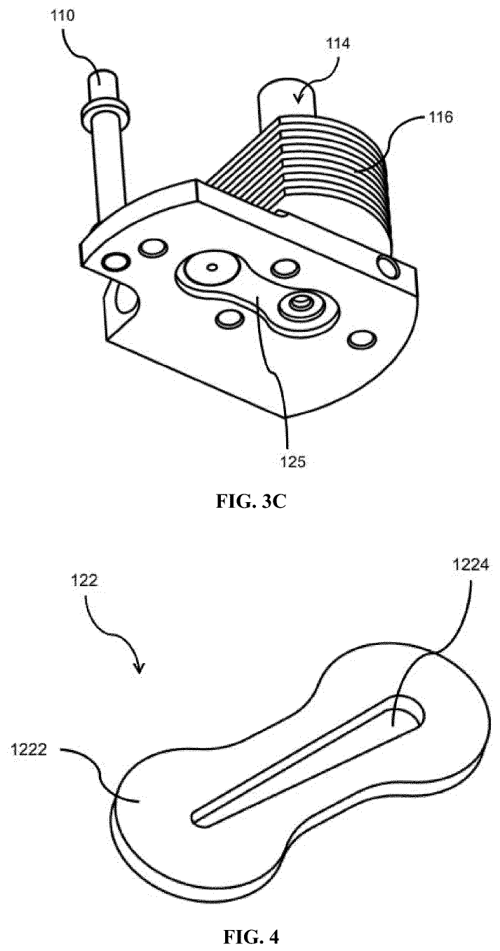

Now referring to FIG. 4, a spacer 122 for a heating unit is shown according to an embodiment.

In an embodiment, the horizontal guiding channel 125 defines a hollow space or an empty space, which is provided in the heat block 150 of the heating unit 100. The space or empty space is adapted to host the spacer 122 as illustrated. The thickness of the spacer 122 is preferably slightly larger than the depth of the empty slot to ensure that the spacer 122 is firmly pressed by the upper part of the bottom part of the heat block 150 when the heating unit is assembled.

In an embodiment, specifically, this spacer 122 is located below the fiber guiding tube 132 and the polymer guiding tube 134, in the bottom part of the heating unit 100.

In an embodiment, the spacer 122 includes a solid part 1222 and a hollow part 1224. The solid part 1222 of the spacer 122 is made of a material having a high thermal conductivity, such as a metal, and preferably copper. Advantageously, the use of copper ensures that the fed polymer or plastic has an evenly distributed temperature, avoiding defaults in the resulting composite article.

In an embodiment, the hollow part 1224 includes a slit having a width which is at least greater than the smallest diameter of the fiber guiding tube 132 and the polymer guiding tube 134. In a specific embodiment, the hollow part 1224 includes a narrowing cutout, the narrowing cutout being large enough for the material outputted by the extruder 140 to be guided into the printing nozzle 123 of the heating unit 100.

This enables guiding the majority if not all the material outputted by the extruder 140 into the printing nozzle 123, leading from the polymer guiding tube 134, having a diameter of approximately 2 millimeters, into the fiber feeding zone, having a diameter of approximately 1 millimeter. The materials used for the aforementioned elements are adapted so that their temperature as well as the temperature of all plastic parts around keep an even temperature. Additionally, all the connections between these elements and parts are sealed, so plastic flowing out can only be guided through the spacer 122 and/or the holes of the guiding tubes, the extruder, and the printing nozzle.

In an embodiment, the spacer includes sheath made of a metal such as copper. The sheath is a little bit thicker than the nominal space available in the heating unit 100 for hosting it.

In an embodiment, the size of the sheath is approximately 1 millimeter, and the cutout is slightly smaller, such as 0.9 millimeter. When the spacer 122 is put in the heating unit, e.g., when it is bolted inside the heating unit, the metal part is pressed against the inside walls of the heating unit, providing an optimal sealing.

Narrowing down the guiding channel further also enables that the plastic moves with increasing speed without any gaps, or dead zones, for the flow of material. This improves the quality of the printing process since no building up of burned coating occurs, thereby avoiding a clogging of the printhead or of the heating unit. This also enables avoiding the appearance of residual plastics or polymers on the sides. Otherwise, such residues might require a maintenance of the printhead after several days of intense uses.

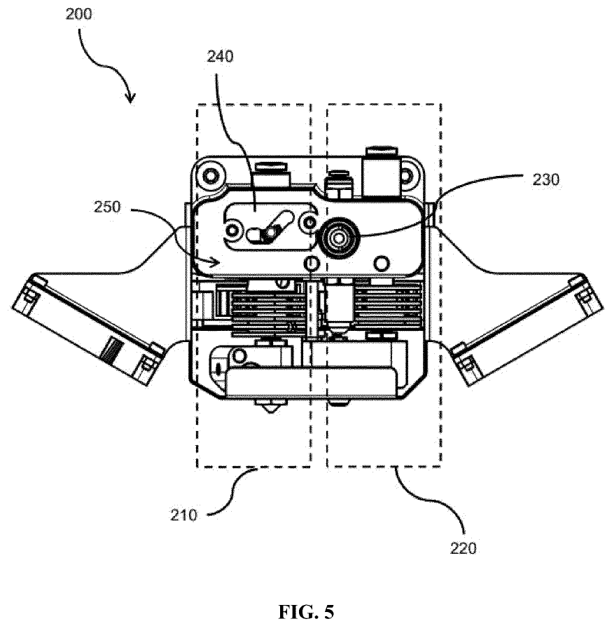

Now referring to FIG. 5, a printhead 200 is shown according to an embodiment.

In this embodiment, the printhead 200 includes a plurality of separate heating units, also called “hotends”.

Specifically, the printhead 200 includes two separate heating units 210 and 220. The first heating unit 210 is a plastic hotend, i.e., a heating unit intended for heating, guiding and/or feeding a plastic filament, while the second heating unit 220 is a composite hotend, i.e., a heating unit intended for heating, guiding and/or feeding a composite filament.

In an embodiment, the printhead may also include other elements, including but not limited to a mechanism for feeding a plastic filament, a mechanism for feeding a reinforcing fiber, another mechanism for cutting the reinforcing fiber, one or more feeding tube for any type of filament and one or more feeding tubes for any type of reinforcing fiber.

In an embodiment, the printhead 200 further includes a main bracket 250 that holds all the components and parts.

In an embodiment, the plastic hotend 210 is adapted to be retractable, for instance by means of a switching mechanism 240.

Advantageously, the switching mechanism 240 includes a horizontal lever that is adapted to rotate with the nozzle. The horizontal lever is further adapted to move along a diagonal axis situated on the main bracket 250. The rotational motion of the lever enables shifting the nozzle vertically.

In addition, the switching mechanism 240 enables positioning the plastic hotend 210 at different height positions, including a position that is either higher or lower than the printing nozzle of the composite hotend 220.

In an embodiment, the plastic hotend 210 is adapted to be fixed to the main bracket 250 and unmovable with respect to the printhead or with respect to the main bracket.

Printhead electrical board is installed beneath the servo and connects all electric components to the control wires that are connected to the main board of the printer.

In an embodiment, the composite hotend 220 includes a cutting mechanism 230 placed on the main bracket of the print head 200.

In an embodiment, the cutting mechanism 230 includes one or more rotatable cylindrical cutters. Preferable, the one or more rotatable cylindrical cutters include a radial hole and at least one cylindrical sleeve that is fixed to the radial hole.

These more rotatable cylindrical cutters enable a high precision fit by cylindrical surfaces. Advantageously, it is possible to put these rotatable cylindrical cutters in a position such that the guiding of filaments through the printhead way is not hindered by any elements.

In an embodiment, the composite hotend 220 further includes a servo motor or machine that is configured to control and rotate the rotatable cylindrical cutters which are adapted to cut or snap a fiber passing through the radial hole.

The above are embodiments of the present invention, which do not limit the scope of the present disclosure. Equivalent structures or equivalent process changes made by using the contents of the present disclosure and drawings, or directly or indirectly applied in other related technical fields, are equally included in the scope of the present disclosure and invention.

What is claimed is:

1. A heating unit (100; 220) for a printhead (200), the heating unit comprising:
at least two guiding tubes (132, 134), each of the guiding tubes being adapted to be connected to an extruder (140); a first guiding tube (132) among the at least two guiding tubes being adapted for guiding a fiber filament from a first inlet (112) of the first guiding tube to the extruder, a second guiding tube (134) among the at least two guiding tubes being adapted for guiding a polymer filament from a second inlet (114) of the second guiding tube to the extruder;
a heating element (151) adapted for melting the polymer filament guided in the second guiding tube (134) to the extruder;
a horizontal guiding channel (125) connected to the extruder (140) and located below the first guiding tube (132) and the second guiding tube (134), the horizontal guiding channel being adapted for guiding the melted polymer from the second guiding tube to the extruder;
the extruder (140), being adapted for forming a composite material by covering, with the melted polymer, the fiber filament guided in the first guiding tube (132) to the extruder, and
a printing nozzle (123) connected to the extruder and adapted for printing a composite part by outputting the composite material outside of the heating unit.

2. The heating unit according to claim 1, wherein the fiber filament is selected among a carbon fiber filament, a glass fiber filament, a composite fiber filament, an optical fiber filament, or a Kevlar fiber filament.

3. The heating unit according to claim 1, wherein the polymer filament is a thermoplastic polymer filament selected form polyetheretherketone, polyetherketoneketone, polyetherimide, polysulfone, polyphenylsulfone and polyethersulfone.

4. The heating unit according to claim 1, further comprising a radiator (116) positioned around a portion of the length of and axially aligned with the vertical axis of the second guiding tube (134) adapted for guiding the polymer filament.

5. The heating unit according to claim 1, wherein the heating unit further comprises a heat block (150); wherein each of the at least two guiding tubes (132, 134) is fixed on an upper side of the heat block; the heat block further comprising the extruder (140) and the printing nozzle (123), the printing nozzle is positioned in the heat block so that the composite material is outputted outwardly from the heat block and from a lower side of the heat block, the lower side being opposite to the upper side, the heat block further comprising the heating element (151).

6. The heating unit according to claim 5, further comprising a pillar (110), the pillar being attached to the heat block, the first guiding tube (132) being located between the pillar (110) and the second guiding tube (134).

7. The heating unit according to claim 5, wherein the heat block (150) comprises a first zone (170), called a thermistor zone, which is adapted to host at least one thermal sensor and/or thermistor; the heat block further comprises a second zone (172), called a heater zone, which is adapted to host the heating element (151).

8. The heating unit according to claim 7, wherein the second zone (172) comprises at least one lodge adapted to host the heating element (151).

9. The heating unit according to claim 5, wherein the horizontal guiding channel (125) comprises a hollow space formed in the heat block (150) of the heating unit (100), wherein the hollow space is located under the at least two guiding tubes (132, 134) and adapted to host a spacer (122) of corresponding size and shape; the at least two guiding tubes are attached to the heat block (150).

10. The heating unit according to claim 5, wherein the heat block (150) comprises an input bushing (121) located under the first guiding tube (132) adapted for guiding the fiber filament, wherein the input bushing (121) has an opening with a diameter adjustable for controlling the flowing of the fiber filament.

11. The heating unit according to claim 10, further comprising an empty space (130) defining an air gap between the first guiding tube (132) and the input bushing (121).

12. The heating unit according to claim 9, further comprising the spacer (122) adapted to fit inside the horizontal guiding channel (125), the spacer comprising a solid part (1222) and a hollow part (1224) located inside the solid part, the solid part being made of a material having a high thermal conductivity, the hollow part comprising a narrowing cutout, the width of the cutout being large enough for guiding the melted polymer towards the printing nozzle (123).

13. A printhead (200) comprising:
a main bracket (250);
two heating units (210, 220) attached to the main bracket, one of the two heating units being the heating unit according to claim 1;
a cutting mechanism (230) attached to the main bracket for cutting the fiber filament, and
a switching mechanism (240) attached to the main bracket for controlling the height of at least one of the two heating units.

14. The printhead according to claim 13, wherein the cutting mechanism (230) comprises one or more rotatable cylindrical cutters, each rotatable cylindrical cutter comprising a radial hole and at least one cylindrical sleeve that is fixed to the radial hole.

15. The printhead according to claim 13, wherein the switching mechanism (240) comprises a lever configured for controlling a vertical position of the printing nozzle of at least one of the two heating units.

16. The printhead according to claim 13, wherein the heating unit further comprises a heat block (150); wherein each of the at least two guiding tubes (132, 134) is fixed on an upper side of the heat block; the heat block further comprising the extruder (140) and the printing nozzle (123), the printing nozzle is positioned in the heat block so that the composite material is outputted outwardly from the heat block and from a lower side of the heat block, the lower side being opposite to the upper side, the heat block further comprising the heating element (151).

17. The printhead according to claim 16, wherein the heat block (150) comprises a first zone (170), called a thermistor zone, which is adapted to host at least one thermal sensor and/or thermistor; the heat block further comprises a second zone (172), called a heater zone, which is adapted to host the heating element (151).

18. The printhead according to claim 16, wherein the horizontal guiding channel (125) comprises a hollow space formed in the heat block (150) of the heating unit (100), wherein the hollow space is located under the at least two guiding tubes (132, 134) and adapted to host a spacer (122) of corresponding size and shape; the at least two guiding tubes are attached to the heat block (150).

19. The printhead according to claim 16, wherein the heat block (150) comprises an input bushing (121) located under the first guiding tube (132) adapted for guiding the fiber filament, wherein the input bushing (121) has an opening with a diameter adjustable for controlling the flowing of the fiber filament.

20. The printhead according to claim 18, wherein the heating unit further comprises the spacer (122) adapted to fit inside the horizontal guiding channel (125), the spacer comprising a solid part (1222) and a hollow part (1224) located inside the solid part, the solid part being made of a material having a high thermal conductivity, the hollow part comprising a narrowing cutout, the width of the cutout being large enough for guiding the melted polymer towards the printing nozzle (123).
